(19) United States
(12) Patent Application Publication
(10) Pub. No.: US 2008/0218592 A1
(43) Pub. Date: Sep. 11, 2008

(54) Method and System for Calibrating a Camera in Production Machines

(75) Inventor: Dirk Jahn, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, München (DE)

(21) Appl. No.: 12/088,029

(22) PCT Filed: Sep. 19, 2006
(86) PCT No.: PCT/EP2006/066493

§ 371 Date: Mar. 25, 2008

(30) Foreign Application Priority Data
Sep. 26, 2005 (DE) 10 2005 045 854.8

(51) Int. Cl. H04N 17/00

(52) U.S. Cl. 348/187; 348/E17.001

(57) ABSTRACT

Method and system for calibrating a camera (12) in the working chamber (10) of a production machine. A calibration object (24) inside the working chamber (10) of the machine is brought to different positions and its picture is taken by the camera (12). The position parameters of the calibration object (24) are assigned to the corresponding pictures taken by the camera (12). The parameters of the camera (12) can be determined on the basis of the thus determined data. According to the invention, the different positions of the calibration object (24) inside the working chamber (10) are determined using the measurement system of the machine in order to obtain particularly precise parameters of the camera (12), the parameters of the camera (12) being determined taking into account the data from the measurement system of the machine.

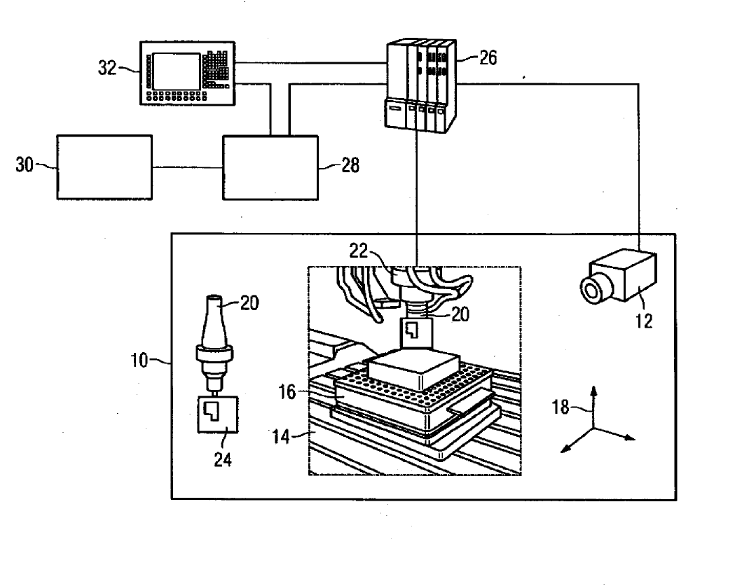

The invention relates to a method and a system for calibrating a camera in a production machine of the type specified in the precharacterizing clause of patent claims 1 and 9.

Such cameras are used in a broad field of application inside production machines to monitor the production process or to determine parameters for the production process. Examples include the monitoring of collisions, the recognition of components, the measuring of components or the recognition of the position of components, in which for this one or more cameras are arranged inside the production machine. To be able to perform such monitoring and/or recognition functions with the camera arranged in the working chamber of the machine with adequate reliability and precision, it must be possible to determine the position of the camera relative to the production machine and the internal parameters of the camera as accurately as possible. In other words, the more exactly the intrinsic and extrinsic parameters of the camera are known, the more precisely and reliably the images or shots taken by the camera can be evaluated. In this case, intrinsic parameters are taken to refer to camera-specific data such as the focal length of its lens or the parameters of the sensor. On the other hand, extrinsic parameters are taken to refer to the position or the coordinates and orientation of the camera inside the working chamber of the production machine.

To determine the extrinsic parameters of the camera using conventional calibration methods, a calibration object, whose shape and dimensions are known is manually put into different positions inside the working chamber of the machine and is recorded by the camera in the process. The parameters of the respective position of the calibration object are assigned to the corresponding recordings of the camera, until enough information or data is present to determine the parameters of the camera. At present, the information or parameters of the calibration object and the respectively associated recordings of the camera are usually calculated in algorithms, which, for example, are based on methods such as the direct linear transformation (DLT) or the like.

The object of the present invention is to improve a method and a system of the type mentioned above in such a way, that a more accurate determination of the intrinsic and extrinsic parameters of the camera can be realized.

According to the invention, this object is achieved by a method and a system for calibrating a camera in a production machine having the characteristics of patent claims 1 and 9, respectively. Advantageous embodiments with expedient and nontrivial developments of the invention are described in the dependent claims.

In the method according to the invention, the different positions of the calibration object inside the working chamber of the machine are determined with the aid of a measuring system of the machine, which is present in any case. In this case, the determination of the position and, in particular, the extrinsic parameters of the camera is carried out taking the data of the measuring system of the machine into account. A production machine or a machine tool usually has such a measuring system on its movement axes, with which adjustments along one or more machine axes can be determined. The transformation to the different coordinate systems—for example, to a machine coordinate system or a tool coordinate system—is then carried out on the basis of known dependences inside the machine.

Thus, according to the present invention, the positioning of the calibration object should no longer, as up until now, be carried out manually, but rather with aid of the measuring system of the machine, which is present in any case. For this, the calibration object is preferably arranged on a movable machine axis of the production machine or on a tool or tool holder in order to be able to determine different positions inside the working chamber of the machine by using the measuring system which captures the adjusting movement of the machine axis or the tool. It is clear that for this the production machine must possess at least one axis, which can be regulated and measured, and by means of which different positions of the calibration object can be determined precisely inside the working chamber of the machine. However, from experience, in the currently usual, conventional machining centers, this precision is in the μm-range, so that the measuring system of the production machine can deliver an adequate accuracy for calibrating the camera. Due to the very precise determination of the position of the calibration object via the machine axes, the recordings required for the calibration of the camera can thus be related very precisely to the parameters acquired by the measuring system. The parameters acquired by the measuring system are then also incorporated into the determination of the position of the camera, so that an extremely precise calibration of the camera inside the production machine can be realized.

If the calibration object is fastened to a tool or a tool holder of the production machine, the zero point of the calibration object is determined relative to a zero point of the tool or of the tool holder (tool center point (TCP)), preferably before the beginning of the measuring method. In this manner, the zero point of the calibration object, which is required for the determination of its position by means of the associated recording of the camera, can be determined in a simple fashion via the zero point of the tool or of the tool holder. In other words, the zero point of the calibration object only has to be determined once compared to the zero point of the tool or of the tool holder. A particularly accurate calibration of the camera can be achieved, if the calibration object is put into different end positions of an acquisition field of the camera inside the working chamber of the machine. Position parameters at a maximum distance—with reference to the acquisition field of the camera—inside the working chamber of the machine are determined thereby, it therefore being possible to minimize an error caused by the measuring system.

It has been shown to be further advantageous to perform the assignment of the parameters of the calibration object to the corresponding recordings of the camera with an evaluation means, which is preferably connected directly to the controller of the production machine or the measuring system thereof. The determination of the position of the camera in this process is preferably performed by a calculation means, which accesses the data of the evaluation means and determines the position of the camera by, for example, direct linear transformation (DLT) or a similar calculation method.

Further advantages, characteristics and details of the invention arise from the following description of a preferred exemplary embodiment as well as the drawing, which shows:

A schematic illustration of the procedure of the method and the system used for this to calibrate a camera in a working chamber of a production machine.

A camera 12 is arranged inside a working chamber 10 of a production machine or machine tool, configured, for example, as a four-axis machining center, whose recordings serve for monitoring, the determination of components, the determination of the position of components, the measuring of components, the monitoring of collisions or the like. So that adequately precise or accurate information and parameters relating to the product being fabricated by the production machine can be determined with aid of the recordings of the camera 12, which can be images or shots, the position of the camera 12 relative to the production machine and the internal parameters of the camera 12 have to be accurately known. Next to the intrinsic parameters of the camera 12, which specify camera-specific characteristics such as the focal length of the lens or parameters of the sensor of the camera 12, the extrinsic parameters of the camera 12 in particular are of great importance for a high precision of the recordings determined by it. In the determination of these extrinsic parameters, the position of the camera 12 relative to the production machine or its working chamber 10 is particularly of great importance.

To accurately calibrate the camera 12 and to determine its parameters, it is arranged at a position inside the working chamber 10 of the machine, where it should fulfill its monitoring and/or recognition function in the later production process. Inside the working chamber 10 of the production machine a workbench 14 is schematically indicated, on which a product which is to be machined later can be fastened by suitable clamping means 16. The workbench 14 in the present exemplary embodiment can be moved along three machine axes in a conventional way, as indicated by the Cartesian coordinate system 18.

Moreover, a tool holder 22, holding and driving a tool 20, can be recognized inside the working chamber 10, which, in the present exemplary embodiment, are also to moved along the tool axes also lying in the coordinate system 18. In the present exemplary embodiment, a calibration object 24, formed as a so-called marker and whose form and dimensions are accurately known, is fastened to the tool 20, which is again illustrated separately in the drawing. In other words, the calibration object 24 is fastened to a movable machine or tool axis of the production machine. Instead of the provided fastening of the calibration object 24 to the tool 20, as in the present exemplary embodiment, it would accordingly also be conceivable, to fasten the calibration object 24 to the workbench 14 or to another movable machine axis.

A control system 26 of the production machine comprises a machine coordinate system and a tool coordinate system, with which the movements of, for example, the workbench 12 or the tool 20 can be defined or determined exactly. After fastening the calibration object 24 to the tool 20 or the tool holder 22, a predefined zero point of the calibration object 24 can be determined relative to a zero point of the tool (tool center point (TCP)) determined by the tool coordinate system of the control system 24. In other words, the zero point of the calibration object 24 is then also known via the position of the zero point of the tool 20—as determined by the tool coordinate system of the control system 26. This follows from the shift of the calibration object 24 relative to the zero point of the tool 20 or the tool holder 22. The calibration of the camera 12 can now be activated by a control panel 28 of the control system 26. For this, the calibration object 24 is put in different positions inside the working chamber 10 of the machine along at least one tool or machine axis by means of the control system 26, these positions or the parameters of the calibration object 24 being determined by means of the tool coordinate system. To achieve a particularly precise calibration, the calibration object 24 is moved up to the end positions of the acquisition field of the camera 12 inside the production machine. The parameters corresponding to the respective position of the calibration object 24 are assigned to the respective assigned recordings of the camera 12 by an evaluation means 28 of the control system 26 and are saved correspondingly. Here, in a fashion matched to each recording of the camera 12, the corresponding zero point of the tool (tool center point (TCP)), and thus also the position of the zero point of the calibration object 24 is read out and saved for further processing.

This process is repeated until enough information has been collected.

The intrinsic and, in particular, the extrinsic parameters of the camera 12 can be determined by a calculation means 30 assigned to the evaluation means 28 or the control system 26 once enough information has been collected by the evaluation means 28. The determination of the parameters of the camera 12 inside the calculation means 30 is carried out taking into account the recordings made at the different positions of the calibration object 24, the zero points of the tool 20 determined for this using the tool or machine coordinate system and the known shift of the zero point of the tool 20 with respect to the zero point of the calibration object 24. In this process, the calculation inside the calculation means 30 is carried out on the basis of known algorithms, for example taking known methods such as the direct linear transformation (DLT) or the like into account, the result of the extrinsic parameters of the camera 12 describing a position thereof in the machine coordinate system when the transformation of the tool coordinate system and the machine coordinate system is read out from the control system 26 and is also incorporated into the calculation.

The determined extrinsic and intrinsic parameters of the camera 12 can be both displayed on the control panel 32 or saved correspondingly in the control system 26. Of course, it is also conceivable to perform the calculation of the parameters of the camera 12 outside the control system 26 or the calculation means 30.

Due to the very high precision of the machine and tool axes of the production machine or the assigned machine and tool coordinate system, the position of the calibration object 24 and ultimately also the position of the camera 12 inside the machine coordinate system can thus be determined extremely precisely, so that a very accurate calibration of the camera 12 inside the working chamber 10 of the production machine can be realized.

1.-13. (canceled)

14. A method for calibrating a camera in a production machine, comprising the steps of:
a) placing a calibration object in different positions inside a production machine;
b) determining the different positions of the calibration object with the aid of a measuring system of the production machine
c) recording the different positions of the calibration object with the camera;
d) assigning parameters of the calibration object corresponding to the recorded camera positions; and
e) determining calibration parameters of the camera from the assigned parameters.

15. The method of claim 14, wherein placing the calibration object includes arranging the calibration object on a movable machine axis of the production machine.

16. The method of one claim 14, wherein placing the calibration object includes fastening the calibration object to a tool or a tool holder of the production machine.

17. The method of claim 16, further comprising the step of determining a zero point of the calibration object relative to a zero point of the tool or of the tool holder.

18. The method of claim 17, wherein the assigned parameters of the calibration object are determined as a function of the tool center point of the tool or the tool holder.

19. The method of claim 14, wherein placing the calibration object includes placing the calibration object at different end positions of an acquisition field of the camera within the production machine.

20. The method of claim 14, wherein the parameters are assigned to the corresponding recorded camera positions with an evaluation means.

21. The method of claim 14, wherein the calibration parameters of the camera are determined using a coordinate system of the production machine or of a tool.

22. A system for calibrating a camera in a production machine, comprising:
a) a calibration object placed at different positions inside the production machine,
b) a measuring system disposed on the production machine for determining the different positions of the calibration object,
c) the camera for recording the calibration object at the different positions inside the production machine, and
d) evaluation means connected to the measuring system of the production machine and configured to assign parameters of the calibration object to the recorded camera positions.

23. The system of claim 22, further comprising calculation means for determining calibration parameters of the camera from the assigned parameters.

24. The system of claim 23, wherein the calculation means is connected to the evaluation means.

25. The system of claim 22, wherein the calibration object is arranged on a movable machine axis of the production machine.

26. The system of claim 23, wherein the production machine comprises a tool or tool holder which supports the calibration object.

27. The system of claim 26, wherein the tool or tool holder is attached to the production machine.
